(19) United States
(12) Patent Application Publication
(10) Pub. No.: US 2005/0174930 A1
(43) Pub. Date: Aug. 11, 2005

(54) System and method for optimized utilization of code resource in communication networks

(75) Inventors: Klaus Ingemann Pedersen, Aalborg (DK); Prehen Mogensen, Gistrup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation, FIN-02150 Espoo (FI)

(21) Appl. No.: 10/516,880

(22) PCT Filed: Jun. 6, 2002
(86) PCT No.: PCT/IB02/02038

(51) Int. Cl. H04J 11/00

(52) U.S. Cl. 370/208; 370/335; 455/101; 375/267; 455/347

(57) ABSTRACT

The invention provides a method, system and network element for providing enhanced utilization of code resource in a cellular systems, preferably a terrestrial cellular CDMA systems, wherein a base station comprises an antenna system which generates several beams A spreading factor (SF) of the root channelization code sets an upper limit on the maximum bit rate. The spreading factor of the root channelization code is selected according to the set of minimum spreading factors assumed for the different beams. Packet scheduling for parallel beams is provided in such a manner that not all beams transmit on downlink, e.g. PDSCH, with high or maximum bit rates (low Spreading Factor) simultaneously. The packet scheduling in the individual beams is coordinated so that only one of the beams is transmitting with a high bit rate during the same time period. Different scheduling slots are balanced so they require nearly the same amount of code resources.

### FIELD AND BACKGROUND OF THE INVENTION

The present invention relates to a system and method for enhancing utilization of code resource in terrestrial or cellular systems, preferably to terrestrial cellular CDMA (Code Division Multiple Access) systems and methods.

The invention addresses issues related to cellular systems, e.g. terrestrial cellular CDMA systems, where there is a need for optimized utilization of code resource. This is e.g. the case for the downlink of UMTS (Universal Mobile Telecommunication System), where a finite set of channelization codes are available. It is known that problems may arise when advanced capacity enhancing features are being introduced such as e.g. smart antennas (SA).

### SUMMARY OF THE INVENTION

According to one aspect, the invention provides a method as defined in the independent method claim.

According to a further aspect, the invention provides a system as defined in the independent system claim.

According to another aspect, the invention provides a network element as defined in the independent network element claim.

The invention provides a code efficient solution for cases where multiple beamforming channels, preferably PDSCHs (PDSCH=Physical Downlink Shared Channel) are applied.

The method, system and network element in accordance with embodiments of the invention preferably provide a code trunking efficient solution. This means that code resources are better utilized, so the BS (Base Station) can carry a higher amount of traffic (e.g. higher number of user) with less scrambling codes. This is a major advantage, as introduction of additional scrambling codes typically results in a capacity loss, as the orthogonality properties are partly destroyed within the cell. The invention therefore results in a capacity gain.

This gain is also present for HSDPA (High Speed Downlink Packet Access), even though HSDPA has the option of using higher order modulation schemes to avoid code blocking. This is true since usage of multiple codes (equivalent to lower spreading factor) is more spectral efficient, compared to using higher order modulation techniques.

### BRIEF DESCRIPTION OF THE DRAWINGS

FIG. 1 shows a block diagram of BS architecture in an embodiment of a system in accordance with the invention when using smart antennas with a grid of fixed downlink beamforming,

FIG. 2 illustrates beam allocation of primary and secondary scrambling code, physical channels carrying data, and common broadcast channels, in case of cell splitting, of an embodiment of a system and method in accordance with the invention,

FIG. 3 shows an illustration of a channelization code tree for under one scrambling code. The black nodes in the tree are reserved for PDSCHs under different beams,

FIG. 4 illustrates an example of smart parallel packet scheduling for optimized code resource allocation, in an embodiment of a system and method in accordance with the invention, and

FIG. 5 shows an example of poor uncoordinated packet scheduling.

### DETAILED DESCRIPTION OF PREFERRED EMBODIMENTS OF THE INVENTION

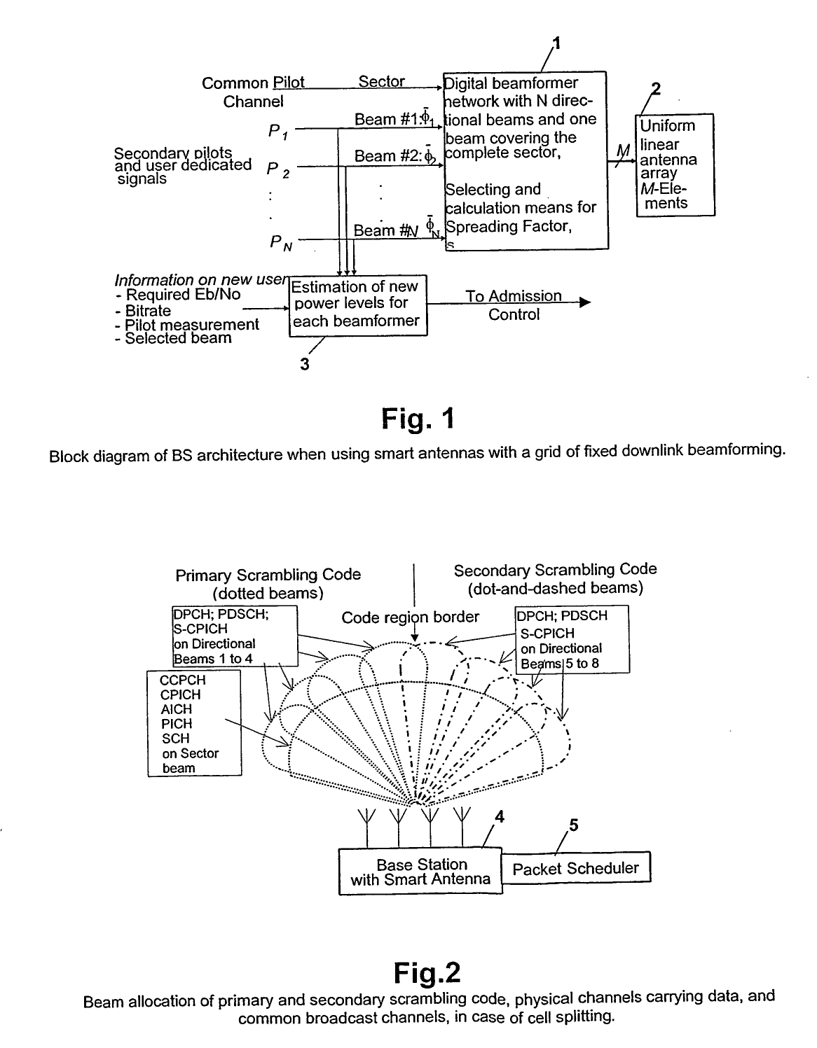

FIG. 1 shows a basic structure of a system in accordance with an embodiment of the invention. FIG. 1 illustrates a block diagram of a BS (base station) architecture when using smart antennas with a grid of fixed downlink beamforming. The system of FIG. 1 involves a network element implemented as a digital beamformer network 1 which generates N directional beams and one beam covering the complete sector. The beamformer network 1 preferably includes two or more up to M beamformers, and sends M signals to a uniform linear antenna array 2 which comprises M antenna elements. The beamformer network 1 includes a selection means for selecting spreading factors, in particular a minimum Spreading Factor for the beams.

The beamformer network 1 receives the signals of the common pilot channel and of the secondary pilots and user dedicated signals P₁ to P_{N} and forms there from the M antenna signals to be applied to the antenna array 2.

An estimation means 3 calculates, i.e. estimates, new power levels for each beamformer of the beamformer network 1, condition on admission of a new user with certain QoS (quality of service) attributes. The estimation means 3 receives the the current average transmit power on the N beams (P₁ to P_{N}), the average transmit power of the sector beam as well as information on new user(s) such as required Eb/No, bit rate, pilot measurement from the user, selected beam. The estimation means 3 generates input to radio resource management algorithms such as AC (admission control).

The present invention also addresses issues related to optimized utilization of code resource in cellular systems, e.g. terrestrial cellular CDMA systems. In some cases, e.g. for downlink of UMTS, only a finite set of channelization codes is available. This causes some potential problems when advanced capacity enhancing features are to be introduced such as e.g. smart antennas (SA).

In this implementation of the invention, the example case of introducing SA (smart antenna) at the BS in UMTS is discussed, and a method and structure for effectively utilizing code resources are shown. In particular the down link shared channel (DSCH) is considered, which is particularly suited for bursty high bit rate packet traffic. Embodiments of the invention also cover the enhanced DSCH called the high speed downlink packet access channel (HSDPA).

For the downlink (DL), a finite set of fixed directional beams is assumed, where each beam carries a secondary common pilot channel (S-CPICH). In addition, it is assumed that a beam (sector beam) is provided which covers the complete sector.

A block diagram for the DL control is pictured in FIG. 1.

All channels which must be broadcast in the entire cell are therefore transmitted on the sector beam shown by a dotted line in FIG. 2, while dedicated channels are transmitted on the directional beams (beams 1 to 8) shown in FIG. 2 by dotted and dot-and-dash lines. This is illustrated in FIG. 2, where the following channels CCPCH, CPICH, AICH, PICH, and SCH are transmitted on the sector beam, while DPCHs are transmitted under narrow directional beams. (CCPCH Common Control Physical Channel, CPICH Common Pilot Channel, AICH Acquisition Indication Channel, PICH Paging Indication Channel, SCH Synchronization Channel)

Note that beamforming on PDSCH also is possible. Different scrambling codes can also be allocated to each beam in order to avoid potential channelization code shortage.

In general, it is typically found that the capacity gain from introducing beamforming antennas is so large, that at least 2 to 3 scrambling codes are needed per cells in order to avoid channelization code blocking (i.e. hard blocking).

As an example, FIG. 2 shows a case where two scrambling codes are deployed, so each scrambling code covers four directional beams. The primary scrambling code is used for the directional beams 1 to 4 shown at the left half portion of FIG. 2, whereas the secondary scrambling code is used for the directional beams 5 to 8 shown at the right half portion of FIG. 2.

FIG. 2 graphically illustrates the beam allocation of primary and secondary scrambling code, physical channels carrying data, and common broadcast channels, in case of cell splitting.

FIG. 2 also shows the base station 4 equipped with the e.g. smart antenna array 2. Further, the base station 4 includes a packet scheduler 5. The packet scheduler 5 can also be arranged remote from the base station 4 at an appropriate position.

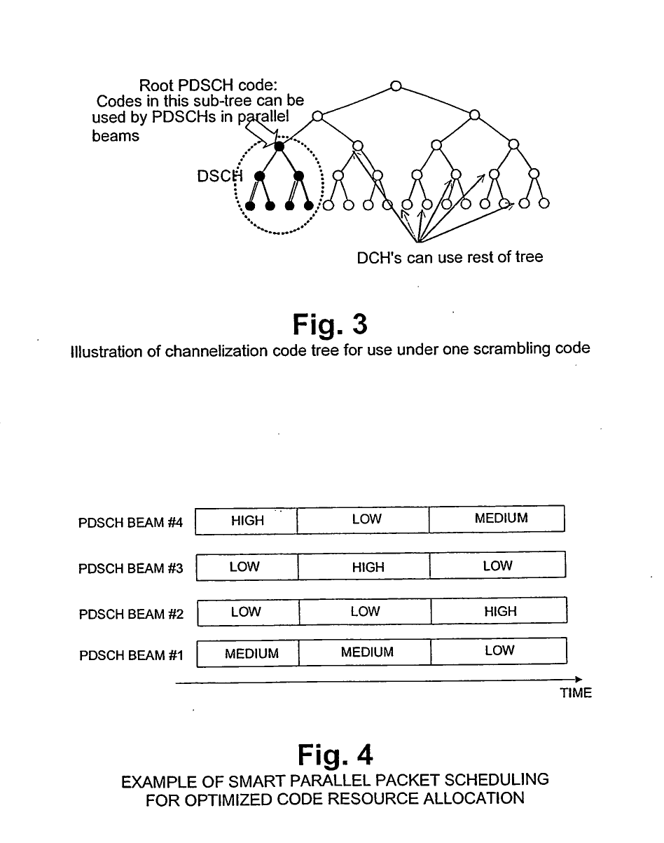

For cells with beamforming SA, it is assumed that one PDSCH is being transmitted under each beam. This means that the PDSCHs transmitted under the same scrambling code, but different beams, all share the same root PDSCH channelization with a certain minimum spreading factor (SF) denoted SF_{DSCHroot}. This is shown in FIG. 3.

FIG. 3 illustrates a channelization code tree for use under one scrambling code. The black nodes in the tree are reserved for PDSCHs under different beams. The root PDSCH code marked by a double-lined arrow is reserved so fast bit rate allocation/change can be accommodated for the different beams. Codes in the sub-tree below the root PDSCH code and circumscribed by a hatched circle can be used by PDSCHs in parallel beams. DCH's marked by simple arrows to the right of the hatched circle can use the rest of the tree.

Alternatively, one logical DSCH (Downlink Shared Channel) may be assigned per beam, so a separate root PDSCH channelization code can be reserved for each beam. However, this option will result in loss of code trunking efficiency, because it is highly unlikely that all PDSCHs under different beams will be operating at high bit rates simultaneously. Application of smart packet scheduling for parallel beams, performed by packet scheduler 5 of FIG. 2, can be designed to avoid such loss of code trunking efficiency. This will be discussed further below.

Using link adaptation (LA) techniques e.g. for one scrambling code of FIG. 3 or for a logical DSCH, the selected bit rate for each UE (user equipment) on the DSCH can be expressed as a function of the power allowed for the PDSCH and the experienced SIR (signal-to-interference-ratio) at the UE. This basically implies that UEs close to the BS typically get assigned a higher bit rate, as these UEs have a higher SIR. However, a UE is not always assigned the bit rate according to the LA criteria based on reserved transmit power and SIR at the UE. There are other limitations such as the SF (Spreading Factor) of the root channelization code which set an upper limit on the maximum bit rate.

In the following, aspects of the invention related to code reservation strategies will be described.

For cases where the PDSCHs under the same scrambling code, but different beams, share the same PDSCH root channelization code, a minimum assumed SF for beam number m (SFₘᵢₙ[m]) will be introduced. This means that the SF of the root PDSCH code should be selected according to the set of minimum SFs assumed for the different beams, i.e.
SF_{DSCH}=f({SFₘᵢₙ[m]}_{mεSC}) (1)
where {SFₘᵢₙ[m]}_{mεSC} is the set of assumed minimum SFs for the beams transmitted under the same scrambling code, where the set SC contains the beam numbers which are transmitted under the same scrambling code. A conservative approach is to select the function f( ) so simultaneous transmission in all the beams under the same scrambling code is possible with the minimum assumed SF. However, the probability of that happing is likely to be small, which lead to the conclusion that the latter approach would result in waste of code resources.

Assuming that one scrambling code will most probably cover C=3−5 beams, at least some of the embodiments of the present invention use the following simplified approach, where

$$\begin{matrix}{SF}_{DSCHroot} = f ( {\{ {SF}_{min} [ m ] \}}_{m ∈ SC} ) \\ = Min \{ {\{ {SF}_{min} [ m ] \}}_{m ∈ SC} \} / Q .\end{matrix} \qquad ( 2 )$$

with Q=2ⁿ and C>Q, where n is a positive integer, i.e. nε[0,1,2,3 . . . ].

Assuming that the root PDSCH code is shared between e.g. C=4 beams, then Q=4 will result in a case where the reserved code resources allow for simultaneous transmission in all four beams with the minimum SF. Thus, code load becomes identical to the case where separate root PDSCH codes are reserved for each beam.

However, by setting Q=2 (assuming C=4 four beams) one obtains a gain in terms of less reserved code resources. Actually, preferably 50% less code resources are reserved compared to the case where separate root PDSCH codes are reserved per beam. As an example, selecting Q=2 (still assuming four beams), the embodiments of the invention can ensure that the beam with the minimum assumed SF can transmit at the maximum allowed-bit rate, while the other PDSCHs under different beams (but same scrambling code) can be active at lower bit rates.

This choice also makes it possible that two PDSCHs are operated simultaneously at Min{{SFₘᵢₙ[m]}_{mεsc}}, assuming that the remaining PDSCHs are silent.

Using smart packet scheduling for parallel beams, it can be avoided that all beams transmit on the PDSCH with high bit rates (low SF) simultaneously. This is illustrated in the following.

In the following, aspects of the invention related to smart parallel packet scheduling will be described.

In order to illustrate the basic principles of smart parallel packet scheduling, an example will be considered where PDSCHs are transmitted under four beams, which all share the same root PDSCH channelization code. Under each of these beams, there are UEs (User Equipments) which can operate at high, medium, and low bit rates.

An example of an appropriate scheduling strategy, applied by packet scheduler 5 shown in FIG. 2, is illustrated in FIG. 4. Here it is seen that the scheduling in the individual beams #1 to #4 is coordinated, so only one of the beams #1 to #4 is transmitting with a high bit rate during the same time period. The different time periods (say scheduling slots) are balanced so they require nearly the same amount of code resources.

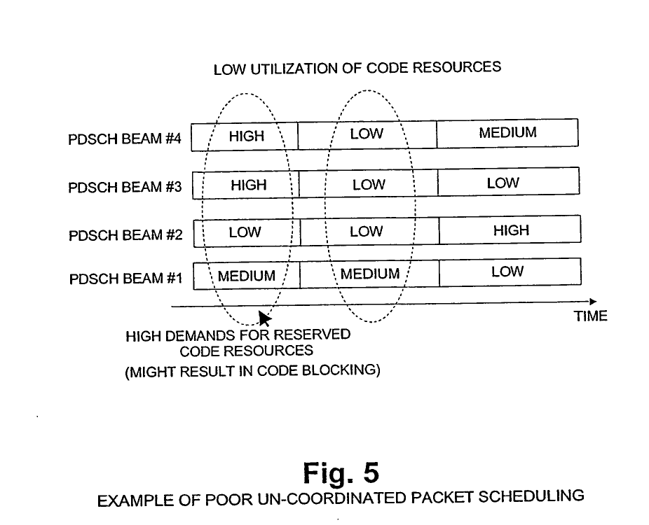

A comparative example of poor scheduling is shown in FIG. 5. Here high bit rates are transmitted to two UEs simultaneously. This sets high requirements to the amount of reserved code resources, and should therefore be avoided whenever possible.

The proposed scheduling strategy can also be combined with quality-of-service (QoS) differentiation schemes, so packets are prioritized according to QoS attributes.

HSDPA is basically an extension of the DSCH. The presented invention is therefore also applicable for the HSDPA.

The invention provides a code efficient solution for cases where multiple beamforming PDSCHs are applied. The method basically provides a code trunking efficient solution. This means that code resources are better utilized, so the BS can carry a-higher amount of traffic (e.g. higher number of user) with less scrambling codes. This is a major advantage, as introduction of additional scrambling codes typically results in a capacity loss, as the orthogonality properties are partly destroyed within the cell. The present invention will therefore result in a capacity gain.

This gain is also present for HSDPA, even though HSDPA has the option of using higher order modulation schemes to avoid code blocking. This is true since usage of multiple codes (equivalent to lower SF) is more spectral efficient, compared to using higher order modulation techniques.

As mentioned earlier, the present invention can be implemented e.g. within the limits of the UMTS specifications (i.e. the 3GPP specifications). The best mode of the invention depends on the selected antenna array configuration, number of beams, scrambling code configuration, etc. For a typical scenario with a four element uniform linear antenna array and six beams, where two scrambling codes are used to cover three beams each (C=3), it is proposed to select Q=2.

The proposed invention can e.g. be implemented in the RNC (radio network controller) and/or the BS, and can e.g. be part of a RAN (Radio Access Network), e.g. an UTRAN (Universal Terrestrial RAN) solution as well as IP-RAN.

The presented algorithm opens for effective utilization of the DSCH when using link adaptation techniques as well as HSDPA.

The invention furthermore improves throughput of packet mode data, e.g. in SA BTS (IP RAN).

While the invention has been described with reference to preferred embodiments, the description is illustrative of the invention and is not to be construed as limiting the invention. The invention may also be implemented in other ways, e.g. by combining, in any arbitrary fashion, one or more features of one or some embodiments with one or more features of other embodiments. Various modifications and applications may occur to those skilled in the art without departing from the scope of the invention as e.g. defined by the appended claims.

1. A method for providing enhanced utilization of code resource in a cellular systems, preferably a terrestrial cellular CDMA systems, wherein a base station comprises an antenna system which generates several beams, and a Spreading Factor (SF) of the root channelization code sets an upper limit on the maximum bit rate, wherein the Spreading Factor of the root channelization code is selected according to the set of minimum Spreading Factors assumed for the different beams.

2. Method according to claim 1 wherein the root channelization code is the root PDSCH code (PDSCH=Physical Downlink Shared Channel).

3. Method according to claim 1, wherein in a case where the channels under a same scrambling code, but different beams, share the same root channelization code, a minimum assumed Spreading Factor for beam number m (SFₘᵢₙ[m]) is defined according to the following equation:
SF_{DSCHroot}=f({SFₘᵢₙ[m]}mεSC)
where SF_{DSCHroot} is the minimum assumed Spreading Factor of the root channelization code of a down link shared channel (DSCH), {SFₘᵢₙ[m]}_{mεSC} is the set of assumed minimum SFs for the beams transmitted under the same scrambling code, where the set SC contains the beam numbers which are transmitted under the same scrambling code.

4. Method according to claim 1, wherein SF_{DSCHroot} is calculated according to the equation
$$\begin{matrix}{SF}_{DSCHroot} = f ( {\{ {SF}_{min} [ m ] \}}_{m ∈ SC} ) \\ = Min \{ {\{ {SF}_{min} [ m ] \}}_{m ∈ SC} \} / Q .\end{matrix}$$
with Q=2ⁿ, where n is a positive integer, i.e. nε[0,1,2,3 . . . ].

5. Method according to claim 4, wherein Q equals or is preferably smaller than, e.g. half, the number of beams sharing the same root PDSCH code, the beam with the minimum assumed SF being allowed to transmit at the maximum allowed bit rate, while the other channels under different beams but same scrambling code can be active at lower bit rates.

6. Method according to claim 3, wherein the function f( ) is selected in such a manner that simultaneous transmission in all the beams under the same scrambling code is possible with the minimum assumed Spreading Factor.

7. Method according to claim 1, wherein packet scheduling for parallel beams is provided in such a manner that not all beams transmit on downlink, e.g. PDSCH, with high or maximum bit rates (low Spreading Factor) simultaneously.

8. Method according to claim 7, wherein packet scheduling in the individual beams is coordinated so that only one of the beams is transmitting with a high bit rate during the same time period, and different time periods, i.e. scheduling slots, are balanced so they require nearly the same amount of code resources.

9. Method according to claim 7, wherein the packet scheduling is based on quality-of-service (QoS) so that packet are prioritized according to QoS attributes.

10. Method according to claim 1, wherein the selection of the Spreading Factor, and/or packet scheduling is being applied to the downlink, preferably the PDSCH (PDSCH=Physical Downlink Shared Channel), or to High Speed Downlink Packet Access (HSDPA).

11. A system for providing enhanced utilization of code resource in a cellular systems, preferably a terrestrial cellular CDMA systems, comprising a base station having an antenna system adapted to generate several beams, wherein a Spreading Factor (SF) of the root channelization code sets an upper limit on the maximum bit rate, comprising a selecting means (1) for selecting the Spreading Factor of the root channelization code according to the set of minimum Spreading Factors assumed for the different beams.

12. System according to claim 11, wherein the root channelization code is the root PDSCH code (PDSCH=Physical Downlink Shared Channel).

13. System according to claim 11, wherein in a case where the channels under a same scrambling code, but different beams, share the same root channelization code, the selection means is adapted to select a minimum assumed Spreading Factor, a minimum assumed Spreading Factor for beam number m (SFₘᵢₙ[m]) being defined according to the following equation:
SF_{DSCHroot}=f({SFₘᵢₙ[m]}_{mεSC}),
where SF_{DSCHroot} is the minimum assumed Spreading Factor of the root channelization code of a down link shared channel (DSCH), {SFₘᵢₙ[m]}_{mεsc} is the set of assumed minimum SFs for the beams transmitted under the same scrambling code, where the set SC contains the beam numbers which are transmitted under the same scrambling code.

14. System according to claim 11, comprising calculating means (1) for calculating SF_{DSCHroot} according to the equation
$$\begin{matrix}{SF}_{DSCHroot} = f ( {\{ {SF}_{min} [ m ] \}}_{m ∈ SC} ) \\ = Min \{ {\{ {SF}_{min} [ m ] \}}_{m ∈ SC} \} / Q .\end{matrix}$$
with Q=2ⁿ, where n is a positive integer, i.e. nε[0,1,2,3 . . . ].

15. System according to claim 14, wherein Q equals or is preferably smaller than, e.g. half, the number of beams sharing the same root PDSCH code, the beam with the minimum assumed SF being allowed to transmit at the maximum allowed bit rate, while the other channels under different beams but same scrambling code can be active at lower bit rates.

16. System according to claim 13, wherein the function f( ) is selected in such a manner that simultaneous transmission in all the beams under the same scrambling code is possible with the minimum assumed Spreading Factor.

17. System according to any one of the preceding system claim 11, comprising a packet scheduler (5) for providing packet scheduling for parallel beams in such a manner that less than all beams, preferably only one beam, are allowed to transmit on the downlink, e.g. PDSCH, with high bit rates (low Spreading Factor) simultaneously.

18. System according to claim 17, wherein the packet scheduler (5) is adapted to coordinate packet scheduling in the individual beams so that only one of the beams is transmitting with a high bit rate during the same time period, and different time periods, i.e. scheduling slots, are balanced so they require nearly the same amount of code resources.

19. System according to claim 17, wherein the packet scheduler (5) is adapted to base packet scheduling on quality-of-service (QoS) so that packet are prioritized according to QoS attributes.

20. System according to any one of the preceding system claim 11, wherein the system is adapted to apply the selection of the Spreading Factor, and/or packet scheduling to the downlink, preferably the PDSCH (PDSCH=Physical Downlink Shared Channel), or to High Speed Downlink Packet Access (HSDPA).

21. Network element to be used in a system for providing enhanced utilization of code resource in a cellular system, said network element, comprising a selecting means (1) for selecting a Spreading Factor of a root channelization code according to a set of minimum Spreading Factors assumed for different beams.

22. Network element as defined in claim 21, comprising a packet scheduler (5) for providing packet scheduling for parallel beams in such a manner that less than all beams, preferably only one beam, are allowed to transmit on the downlink, e.g. PDSCH, with high bit rates (low Spreading Factor) simultaneously.
